(19) United States
(12) Patent Application Publication
(10) Pub. No.: US 2002/0012075 A1
(43) Pub. Date: Jan. 31, 2002

(54) Plasma display panel driving method

(75) Inventors: Tetsuo Nagakubo, Nakakoma-gun (JP); Tetsuya Shigeta, Nakakoma-gun (JP); Hirofumi Honda, Nakakoma-gun (JP)

Correspondence Address: SUGHRUE MION ZINN,, MACPEAK & SEAS, PLLC, 2100 Pennsylvania Avenue, NW, Washington, DC, 20037-3213, US

(73) Assignee: PIONEER CORPORATION

(21) Appl. No.: 09/873,318

(22) Filed: Jun. 5, 2001

(30) Foreign Application Priority Data
Jun. 6, 2000 (JP) 2000-168734

(51) Int. Cl. H04N 5/66; H04N 9/12

(52) U.S. Cl. 348/797

(57) ABSTRACT

A method of driving a plasma display panel which prevents a burning phenomenon when a still image is displayed. A plasma display device includes a plurality of row electrodes formed in pairs corresponding to each display line, a plurality of column electrodes arranged to cross the row electrodes to form a discharge cell corresponding to one pixel at each intersection with a pair of the row electrodes, and a driving controller for controlling driving of the row electrodes and the column electrodes. A gradation display of input pixel data is performed by dividing one field display period into a plurality of subfields. The driving controller, when one field of input pixel data is displayed, changes the number of reset discharges for initializing all discharge cells depending on whether an image to be displayed is a still image or a moving image.

### BACKGROUND OF THE INVENTION

1. Field of the Invention

This present invention relates to a method for driving a matrix display type of plasma display panel.

2. Background of the Invention

An AC type (alternate current discharge) of PDP is wellknown as one of display panels (hereinafter designated as a matrix type of PDP).

The AC type of PDP comprises a plurality of column electrodes (address electrodes) and a plurality of paired row electrodes arranged perpendicular to the column electrodes to form a scanning line. The row electrodes and column electrodes are covered with a dielectric layer to separate both electrodes from a discharge space. The PDP employs a structure in which a discharge cell corresponding to one pixel is formed at an intersection of a pair of row electrodes and a column electrode.

Japanese patent laid-open No. 4-195087 discloses a method, so-called subfield method, for performing a halftone display of input video signals on the PDP. This method is that one field display period is divided into N subfields in which light is emitted for a time period corresponding to weighting of each bit digit of N-bit pixel data.

When the subfield method is used, assuming that pixel data generated by converted video signals comprises six bits, one field period is divided into six subfields SF1, SF2, . . . , and SF6, and light is emitted in each subfield. By sequentially performing light emission in six subfields, one field of image can be represented over 64 levels of gradation.

Further, each subfield comprises a simultaneous reset step Rc, a pixel data writing step Wc, and a light emission sustaining step Ic. In the simultaneous reset step Rc, all discharge cells of the PDP are simultaneously discharged (reset discharge), so that wall charges are uniformly extinguished in all the discharge cells. In the next pixel data writing step Wc, a selective writing discharge is produced in each discharge cell in accordance with pixel data. At this time, in a discharge cell in which the writing discharge is performed, a wall charge is set to a “light emitting cell.” On the other hand, a discharge cell in which the writing discharge has not been performed remains without the formation of a wall charge, so that it is set to a “non-light emitting cell.” In the light emission sustaining step Ic, only the light emitting cells are forced to continue a discharge light emitting state for a duration corresponding to a weighted length of each subfield. In this way, the sustaining light emission is performed at a light emitting duration ratio of 1:2:4:8:16:32 in order in each subfield SF1-SF6.

However, when a still image without motions is displayed for a long time, the PDP may experience a so-called burning phenomenon so that the still image remains as an afterimage when another image is displayed.

### OBJECT AND SUMMARY OF THE INVENTION

In view of the problem mentioned above, it is an object of the present invention to provide a method of driving a plasma display device which is capable of preventing the burning phenomenon to display a good image with satisfactory quality.

According to one aspect, the present invention is characterized by a method for driving a plasma display panel comprising a plurality of paired row electrodes, a plurality of column electrodes arranged to cross said plurality of paired row electrodes to form a discharge cell corresponding to a pixel at each intersection with one of said plurality of paired row electrodes, a first driving circuit for generating driving pulses for driving said plurality of paired row electrodes, and a second driving circuit for generating driving pulses for driving said plurality of column electrodes. The method comprises the steps of: sampling input video signals to convert the sampled signals into pixel data for each field display period, dividing each said field display period into a plurality of subfields to perform a gradation display for said input video signals, and performing a reset discharge in said each field display period to initialize all of said discharge cells. Therefore, the number of reset discharges is increased when an image displayed by said input video signals is a still image.

According to anther aspect, the present invention is characterized by a method for driving a plasma display panel comprising a plurality of paired row electrodes, a plurality of column electrodes arranged to cross said plurality of paired row electrodes to form a discharge cell corresponding to a pixel at each intersection with one of said plurality of paired row electrodes, a first driving circuit for generating driving pulses for driving said plurality of paired row electrodes, and a second driving circuit for generating driving pulses for driving said plurality of column electrodes. The method comprises the steps of sampling input video signals to convert the sampled signals to pixel data every field display period, dividing each said field display period into a plurality of subfields to perform a gradation display of said input video signals, and performing a reset discharge in each one of said subfields to initialize all of said discharge cells. Therefore, the number of reset discharges is increased when an image displayed by said input video signals is a still image.

According to further aspect, the present invention is characterized by a method for driving a plasma display panel comprising a plurality of paired row electrodes, a plurality of column electrodes arranged to cross said plurality of paired row electrodes to form a discharge cell corresponding to a pixel at each intersection with one of said paired row electrodes, a first driving circuit for generating driving pulses for driving said plurality of paired row electrodes, and a second driving circuit for generating driving pulses for driving said column electrodes. The method comprises the steps of sampling input video signals to convert the sampled signals into pixel data for each field display period, dividing each said field display period into a plurality of subfields to perform a gradation display of said input video signals, and performing a reset discharge only in a leading subfield in said field to initialize all of said discharge cells. Therefore, the number of reset discharges is increased when an image displayed by said input video signals is a still image.

According to the present invention, when an input video signal is displayed, the number of reset discharges for initializing all discharge cells in each field display period is changed depending on the type of a displayed image represented by the input video signal, i.e., whether it is a still image or a moving image, it is possible to prevent the burning phenomenon on the screen, which may be seen when a still image is displayed, to improve the quality of the displayed image.

### BRIEF DESCRIPTION OF THE SEVERAL VIEWS OF THE DRAWINGS

The aforementioned aspects and other features of the invention are explained in the following description, taken in connection with the accompanying drawing figures wherein:

FIG. 1 is a block diagram illustrating a plasma display device for driving a plasma display panel in accordance with a driving method according to the present invention;

FIG. 2 is a view illustrating a light emission driving format for performing a halftone display at 256 gradation levels;

FIG. 3 is a chart showing an example of application timings of several kinds of driving pulses applied to a PDP 10;

FIG. 4 is a view illustrating a light emission driving format based on the driving method of the present invention;

FIG. 5 is a flow chart of a routine for changing the number of reset discharges in accordance with the driving method of the present invention;

FIG. 6 is a view showing a second embodiment of application timings of several kinds of driving pulses applied to the PDP 10;

FIG. 7 is a view showing a third embodiment of application timings of several kinds of driving pulses applied to the PDP 10;

FIG. 8 is a block diagram of another embodiment of a plasma display device for driving a plasma display panel in accordance with the driving method of the present invention;

FIG. 9 is a view showing an example of application timings of several kinds of driving pulses applied to a PDP 10;

FIG. 10 is a view illustrating a light emission driving format based on the driving method of the present invention;

FIG. 11 is a view showing an example of light emission driving pattern performed on the basis of the light emission driving format illustrated in FIG. 10;

FIG. 12 is a block diagram illustrating an internal configuration of a data converter 30; and

FIG. 13 is a diagram showing all patterns of light emission driving performed on the basis of the light emission driving format illustrated in FIG. 10, and an example of conversion table when the light emission driving is performed.

### DETAILED DESCRIPTION OF THE INVENTION

A first embodiment of the present invention will be described with reference to the drawings.

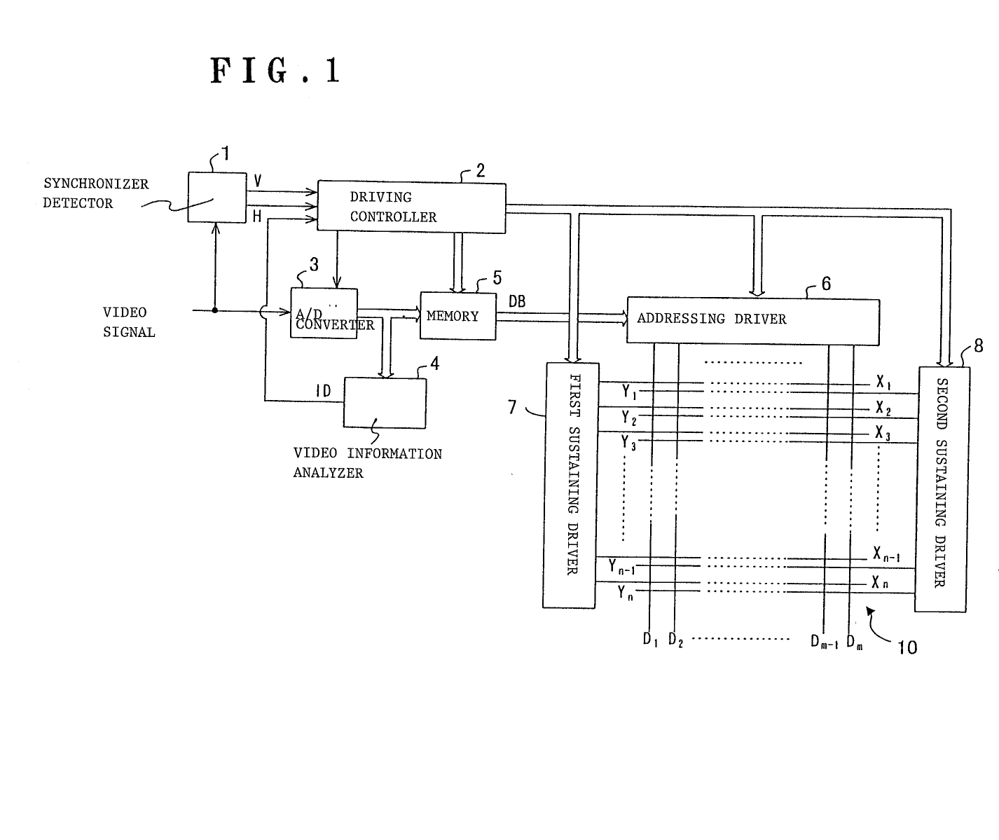

FIG. 1 is a diagram illustrating a general configuration of a plasma display device which comprises a driver for driving a plasma display panel (hereinafter designated as a PDP) in accordance with a method of present invention.

As illustrated in FIG. 1, the plasma display device comprises a PDP 10 as a plasma display, and a driver which is composed of several kinds of functional modules.

In FIG. 1, the PDP 10 comprises m column electrodes D₁-Dₘ as address electrodes, and n row electrodes X₁-Xₙ and row electrodes Y₁-Y₁, which are arranged to intersect the column electrodes. Each of the row electrodes X₁-Xₙ pairs up with the corresponding one of row electrodes Y₁-Yₙ to provide first to n-th display lines on the PDP 10. For example, a pair of row electrodes on the first row on the PDP 10 comprises row electrodes X₁ and Yₙ, and a pair of row electrodes on the n-th row comprises row electrodes Xₙ and Yₙ.

Further, a discharge space filled with a discharge gas is formed between the column electrodes D and the row electrodes X₁-Xₙ and Y₁-Yₙ. Then, a pixel cell corresponding to one pixel is formed at an intersection of a column electrode and a pair of row electrodes which surrounds the discharge cell. In other words, there are m discharge cells on one display line. It should be noted that m equals the number of the column electrodes.

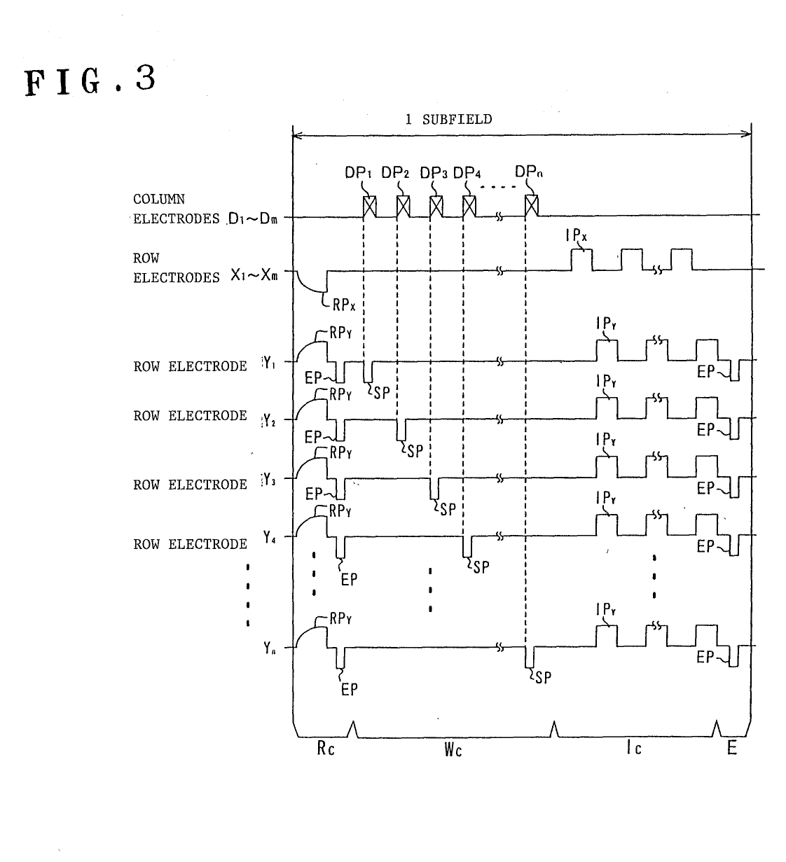

The driver comprises a synchronizer detector 1, a driving controller 2, an A/D converter 3, a video information analyzer 4, a memory 5, an addressing driver 6, a first sustaining driver 7, and a second sustaining driver 8. The driver divides one field display period into six subfields SF1-SF6, for example, as illustrated in FIG. 3 to drive the PDP 10 based on the aforementioned subfield method. At this time, the driver unit executes a simultaneous reset step Rc, a pixel data writing step Wc, a light emission sustaining step Ic, and an erasure step E in a subfield.

The synchronizer detector 1 detects a vertical synchronization signal from input video signals to generate a vertical synchronization detecting signal V. The detector 1 also detects a horizontal synchronization signal to generate a horizontal synchronization detecting signal H to supply the vertical and horizontal synchronization detecting signals V, H to the driving controller 2.

The driving controller 2 generates a clock signal to the A/D converter 3 and write/read signals to the memory 5 in synchronism with the horizontal and vertical synchronization detecting signals V, H. The driving controller 2 also generates several kinds of timing signals for controlling the addressing driver 6, the first sustaining driver 7, and the second sustaining driver 8 in synchronism with the horizontal and vertical synchronization detecting signals V, H.

The A/D converter 3 samples an analog input video signal in response to a clock signal supplied from the driving controller 2. Next, the A/D converter 3 converts the sampled signal to 6-bit pixel data PD representative of a luminance level of each pixel to supply the 6-bit pixel data PD to the memory 5.

The video information analyzer 4 receives the pixel data PD. The video information analyzer 4 then determines whether the input video signals are a still image or a moving image on the basis of the received pixel data to generate image information ID. Then, the analyzer 4 supplies the image information ID to the driving controller 2.

When the driving controller 2 receives the image information ID from the video information analyzer 4, the driving controller 2 selects a configuration pattern of one field for controlling light emission for the PDP from two configuration patterns (which will be described later) in accordance with the image information ID. Then, the driving controller 2 generates signals required for actually driving the PDP, i.e., a pixel data timing signal, a reset timing signal, a scanning timing signal, and a sustaining timing signal dependently on the selected configuration pattern of a field.

The memory 5 sequentially writes the pixel data PD supplied from the A/D converter 3 in response to a write signal supplied from the driving controller 2. Then, each time the memory receives the pixel data PD for one screen, i.e., (n×m) pixel data PD from pixel data PD₁₁ corresponding to the pixel at the first row, first column to the pixel data PDₙₘ corresponding to a pixel at the n-th row, n-th column, the memory 5 performs the following reading operation in response to a read signal from the driving controller 2.

In the first subfield SF1, the memory 5 regards the first bit of each of drive pixel data PD₁₁-PDₙₘ as a drive pixel data bit DB1₁₁-DB1ₙₘ, and read and supplies them for each display line to the addressing driver 6. In the next subfield SF2, the memory 5 regards the second bit of each of pixel data PD₁₁-PDₙₘ as a driving pixel data bit DB2₁₁-DB2ₙₘ, and reads and supplies the driving pixel data bit DB2₁₁-DB2ₙₘ for each display line to the addressing driver 6. In other words, as described above, data of bit corresponding to each of the pixel data PD₁₁-PDₙₘ is read for every display line, and supplied to the addressing driver 6 in every subfields SFi (1≦i≦6). Then, in the last subfield SF6, the memory 5 regards the sixth bit of each of pixel data PD₁₁-PDₙₘ as a driving pixel data bit DB4₁₁-DB4ₙₘ, and reads them for each display line and supplies them to the addressing driver 6.

The addressing driver 6 generates pixel data pulses DP₁-DPₘ having a voltage corresponding to a logical level of pixel data bit group for a line read from the memory 5, and applies them to the column electrodes D₁-Dₘ of the PDP 10, respectively.

The first sustaining driver 7 generates a reset pulse RP_{X} for controlling the amount of residual charge, a sustaining pulse IP_{X} for sustaining a discharge light emitting state, and an erasure pulse EP for stopping a sustaining discharge, in response to several kinds of timing signals supplied from the driving controller 2, and applies them to the row electrodes X₁-Xₙ of the PDP 10.

The second sustaining driver 8 generates a reset pulse RP_{Y} for controlling the amount of residual charge, a scanning pulse SP for writing pixel data, and a sustaining pulse IP_{Y} for sustaining a discharge light emitting state in response to several kinds of timing signals supplied from the driving controller 2, and applies them to the row electrodes Y₁-Yₙ of the PDP 10.

Next, a first embodiment of an operation for the PDP will be described with reference to FIG. 3.

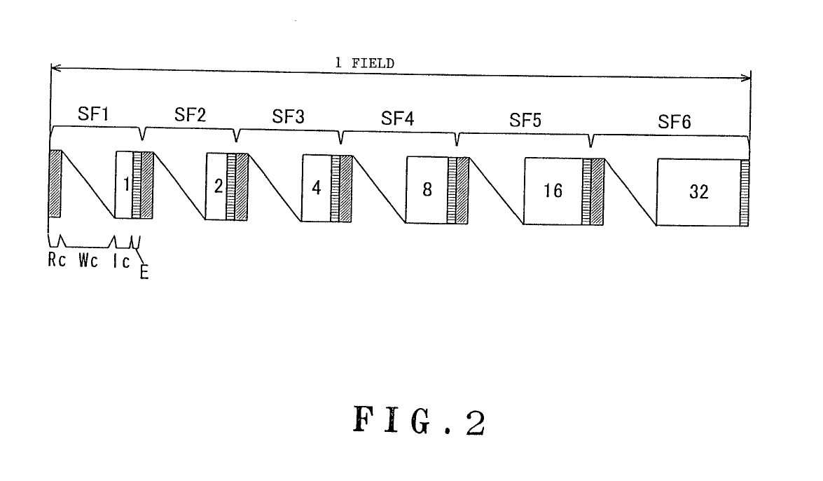

There exist two configurations for subfields in one field to be selected in accordance with the pixel information ID of a field of pixel data PD. As illustrated in FIG. 2, one field is comprised of six subfields SF1-SF6 in order. The driver performs gradation driving for the PDP 10 by means of the subfield method.

A subfield is basically comprised of a simultaneous reset step Rc, a pixel data writing step Wc, a light emission sustaining step Ic, and an erasure step E. From the beginning of a subfield, the simultaneous reset step Rc, the pixel data writing step Wc, the light emission sustaining step Ic, and the erasure step E are performed in order. It should be noted that the simultaneous reset step Rc may be omitted dependently on a subfield.

Next, the operation in each step will be described.

In FIG. 3, in the simultaneous reset step Rc, the first sustaining driver 7 preferably generates reset pulses RPX having a negative polarity and applies the pulses to the row electrodes X₁-Xₙ. Further, simultaneously with the generation of the reset pulses RP_{X}, the second sustaining driver 8 generates reset pulses RP_{Y} of positive polarity and applies the pulses to the row electrodes Y₁-Yₙ. In response to the simultaneous application of the reset pulses RP_{X} and RP_{Y}, reset discharges occur in all discharge cells of the PDP 10 to produce wall charges and space charges in all of the discharge cell. Immediately after that, the second sustaining driver 8 generates erasure pulses EP of a negative polarity and apply the pulses to the row electrodes Y₁-Yₙ. In response to the application of the erasure pulse EP, a discharge occurs in all the discharge cells to extinguish the wall charges in the discharge cells. In this way, all the discharge cells are set to “non-light emitting cell” states.

Next, in the pixel data writing step Wc, the addressing driver 6 generates a pixel data pulse having a pulse voltage corresponding to a driving pixel data bit DB supplied from the memory 5. For example, the addressing driver 6 generates a pixel data pulse at a high voltage when the logical level of the driving pixel data bit DB is “1” and generates a pixel data pulse at a low voltage (0 volt) when “0.” Then, the addressing driver 6 links the pixel data pulses with the corresponding one of the first through n-th display lines and sequentially applies the column electrodes D₁-Dₘ with pixel data pulse groups DP₁-DPₙ which are divides to the corresponding display line.

Further, in the pixel data writing step Wc, the second sustaining driver 8 generates scanning pulses SP of negative polarity at the same timing as the application timing of the pixel data pulse groups DP₁-DPₙ, and sequentially applies the scanning pulses to the row electrodes Y₁-Yₙ. Here, a discharge occurs only in discharge cells at intersections of display lines applied with the scanning pulse SP and “columns electrodes” applied with the pixel data pulses at the high voltage (selective writing discharge). Since the application of voltages by the scanning pulses SP and the pixel data pulse groups DP continues after termination of the discharge, the wall charge is gradually formed in the discharge cell, so that the discharge cell is set to a “light emitting cell.”0 On the other hand, the selective writing discharge as described above is not produced in a discharge cell which is applied with the pixel data pulse at the low voltage and the scanning pulse SP. That is, the discharge cell remains as a “non-light emitting cell.” Therefore, in the pixel data writing step Wc, each of the discharge cells in the PDP 10 is set to a state (either of a “light emitting cell” and a “non-light emitting cell”) corresponding to the pixel data PD.

Next, in the light emission sustaining step Ic, the first sustaining driver 7 and the second sustaining driver 8 alternately apply the sustaining pulses IP_{X} and IP_{Y} of positive polarity to the row electrodes X₁-Xₙ and Y₁-Yₙ. At this time, the number of application of the sustaining pulses IP (or a period for applying the sustain pulses) in the light emission sustaining step Ic differs from one subfield to another in one field. Specifically, when the number of applications in the subfield SF1 is assumed to be “1,” the number of applications of the sustaining pulses IP in the other subfields SF2-SF6 are as follows:

SF1: 1

SF2: 2

SF3: 4

SF4: 8

SF5: 16

SF6: 32

By the application of the sustaining pulses, only discharge cells in which the wall charges exist, i.e., the discharge cells set to the “light emitting cell” discharge each time the sustaining pulses IP_{X} and IP_{Y} are applied, and sustain the light emitting state associated with the discharge by the number of the applications of the sustaining pulses (or for the period for applying the sustaining pulses). On the other hand, discharge cells which have been set to the “non-light emitting cell” do not at all emit light since no discharge can occur by the application of the sustaining pulses.

Further, in the erasure step E, the second sustaining driver 8 generates erasure pulses EP of negative polarity, and then supplies the erasure pulses to all the row electrodes Y₁-Yₙ at the same timing. By the application of the erasure pulses, a discharge occurs in the discharge cells which have been set to “light emission” to extinguish the wall charges remaining in the discharge cells.

In this way, in each subfield, each discharge cell is forced to selectively discharge in accordance with pixel data to specify the light emission state of the cell and to form a wall charge in the discharge cell. Next, in the light emission sustaining step Ic of each subfield, only discharge cells formed with the wall charges (“light emitting cells”) are forced to discharge by the number (or a period) of times allocated to the subfield to continue a light emitting state associated with the discharge. Therefore, by sequentially executing six subfields, light emission occurs the number of times (period) in accordance with a luminance level of an input video signal in each field, so that an intermediate luminance can be displayed corresponding to the input video signal.

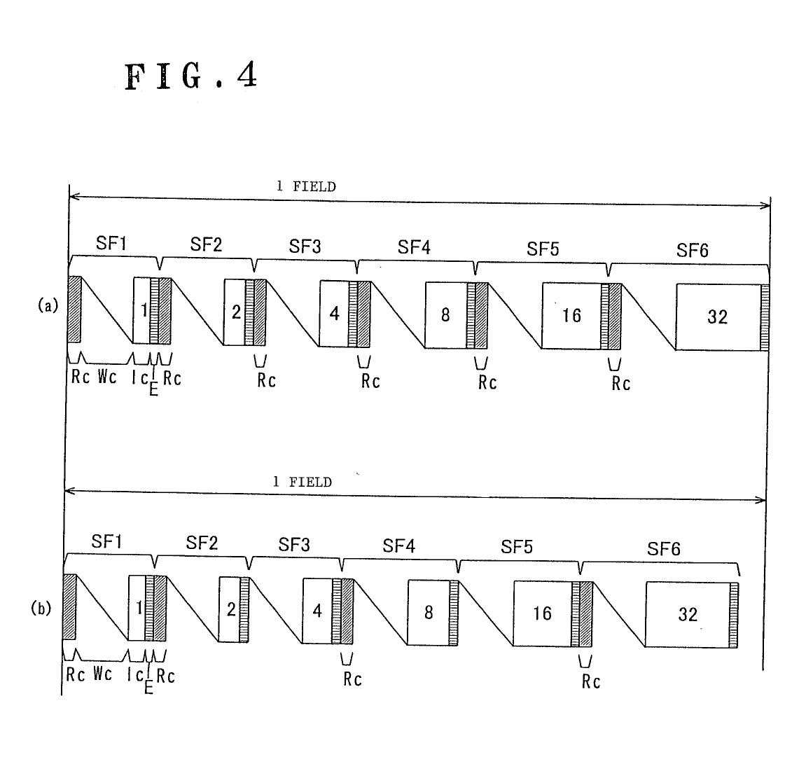

Next, the two types of configuration patterns for one field will be described with reference to FIG. 4.

A first configuration pattern, as illustrated in FIG. 4(a), is such that the simultaneous reset step Rc is performed in each of all the subfields SF1-SF6 which make up one field.

A second configuration pattern, as illustrated in FIG. 4(b), performs the simultaneous reset steps Rc three times in one field. That is, the first simultaneous reset step Rc is performed in the first subfield SF1, and the second and the third simultaneous reset steps Rc are done in the forth and sixth subfields SF4, SF6.

Next, a method of selecting a configuration pattern for one field will be described. The configuration pattern for one field is selected depending on the type of image composed by an input video signal, i.e., whether it is a still image or a moving image.

Generally, a discharge in a discharge cell depends on a wall charge and a space charge remaining in the discharge cell, in addition to an applied voltage pulse. Therefore, even if a voltage level of a pulse applied to discharge cells is the same, the discharge varies depending on the amounts of the wall charge and the space charge remaining in the discharge cell. It has also been found that the amounts of remaining charges in discharge cells vary depending on the number of discharges induced within a predetermined time period.

Therefore, for example, when the same image is continuously displayed on the PDP for a fixed time period, i.e., when a still image is displayed, the same pixel data is repetitively supplied to one discharge cell. Thus, a discharge cell, for which light emission has been selected, emits light for many times due to a sustaining discharge as compared with a discharge cell for which non-light emission has been selected. Therefore, in the discharge cell for which light emission has bee selected, the amount of residual charge is gradually increasing over time. For this reason, when a still image is continuously displayed for a long time period, the discharge cell may emit light at a luminance higher than that corresponding to pixel data in the sustaining discharge step due to the increased amount of residual charge, thereby burning the image on fluorescent materials formed on each of the discharge cells.

Thus, for avoiding the foregoing phenomenon, i.e., for making constant the amount of wall charges remaining in discharge cells, a reset discharge is performed in every subfield to make constant the amount of residual charges in the discharge cells before pixel data is written thereinto.

On the other hand, when a moving image is displayed on the PDP, paying attention to pixel data displayed on one discharge cell, the pixel data is changing field by field, so that the amount of residual charges in the discharge cell is substantially not changed due to a discharge which continues for a long time period. Therefore, no reset discharge need be performed every subfield.

For the reason set forth above, when a still image is displayed, the number of reset discharges is increased in one field as compared with the case where a moving image is displayed, thereby maintaining the constant amount of residual charges in the discharge cells.

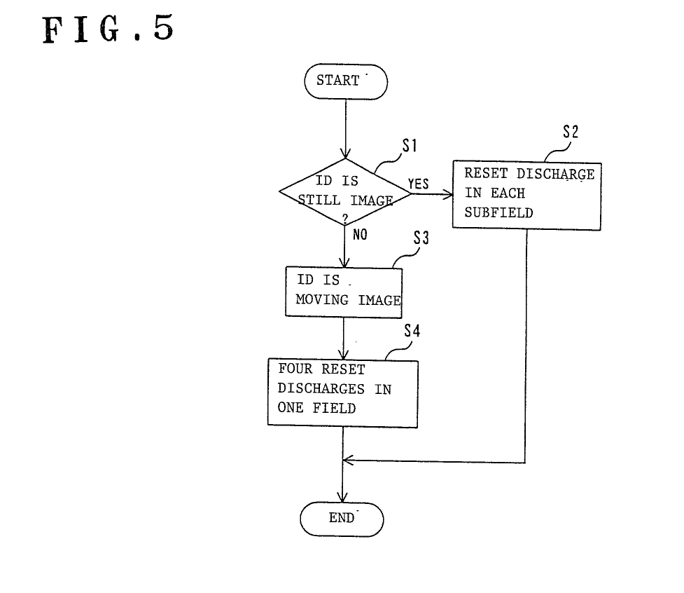

In the following, the selection of a configuration pattern for one field will be described with reference to FIGS. 4 and 5.

When image information ID supplied from the video information analyzer 4 is a still image (step S1), the driving controller 2 selects the configuration pattern illustrated in FIG. 4(a) as a configuration pattern for one field, and performs the simultaneous reset discharge in each subfield (step S2), uniforming the amount of residual charges within the discharge cells before writing pixel data.

When the image information ID is a moving image (step S3), the driving controller 2 selects the configuration pattern illustrated in FIG. 4(b) as a configuration pattern for one field. In other words, four simultaneous reset discharge is performed in one field (step S4).

The determination of a still image or a moving image, composed of an input video signal, is made based on the total number of discharge cells to which different pixel data is supplied, for example, in two consecutive fields of video signal. Specifically, when the total number of discharge cells to which different pixel data is consecutively supplied is equal to or less than a predetermined number, the image is determined as a still image. On the other hand, when the total number of discharge cells to which different pixel data exceeds the predetermined number, the image is determined as a moving image. The determination of a still image or a moving image, however, is not limited to that described in this embodiment, but may take any appropriate means which is generally used in determining a still image or a moving image.

As described above, the configuration pattern is selected for discharges in one field depending on whether an image to be displayed is a still image or a moving image.

In this way, when the type of an image to be displayed is a still image, the number of simultaneous reset discharges in one field is larger as compared with displaying a moving image. Therefore it is possible to display the image of good quality while preventing the burning phenomenon which is likely to occur when a still image is displayed.

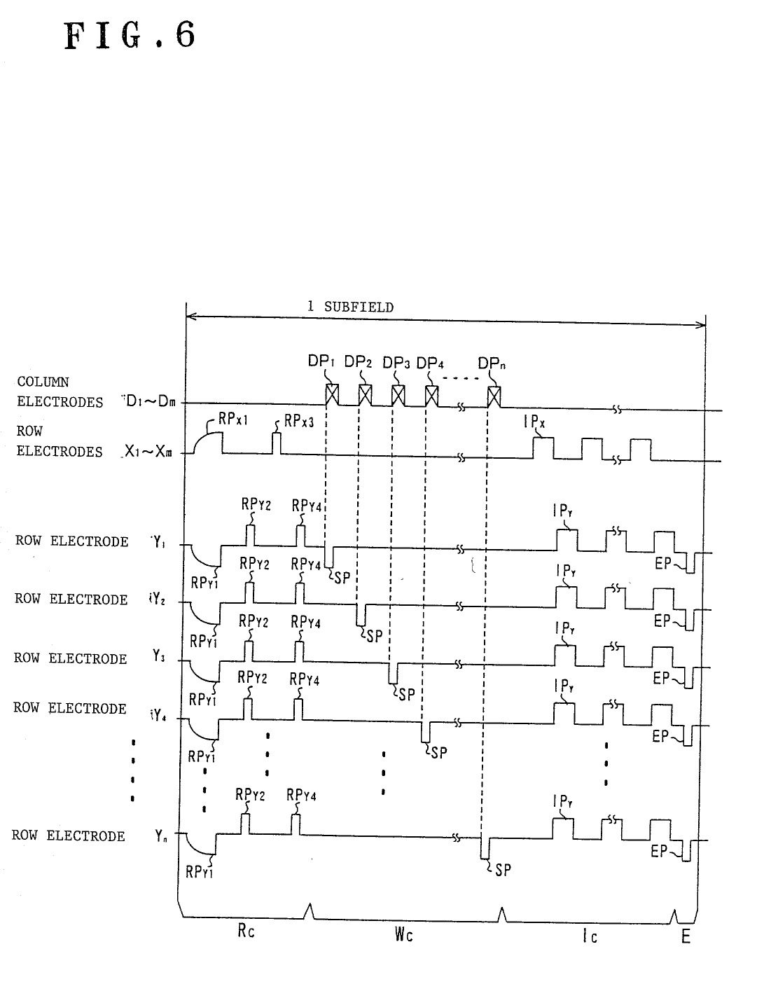

Next, a second embodiment of the present invention will be described with reference to FIGS. 4(a) and 6.

One field is comprised of six subfields, similarly to the first embodiment. Each subfield comprises a simultaneous reset step Rc, a pixel data writing step Wc, a light emission sustaining step Ic, and an erasure step E, as illustrated in FIG. 6. The light emission sustaining step Ic and the erasure step E are similar to the first embodiment, respectively.

In the simultaneous reset step Rc, the first sustaining driver 7 generates reset pulses RP_{X1} of positive polarity, which slowly rises for example, and applies the pulses to the row electrodes X₁-Xₙ. Further, simultaneously with the reset pulses RP_{X1}, the second sustaining driver 8 generates reset pulses RP_{Y1} of negative polarity, which slowly falls, and applies the pulses to the row electrodes Y₁-Yₙ. In response to the simultaneously applied reset pulses PR_{X1} and PR_{Y1}, a first reset discharge occurs in all the discharge cells of the PDP 10 to generate a wall charge and a space charge in each discharge cell. Subsequently, discharges are performed three times, i.e., a second discharge by second reset pulses PR_{Y2} from the sustaining driver 8; a third discharge by third reset pulses RP_{X3} from the sustaining driver 7; and a fourth discharge by fourth reset pulses RP_{Y4} from the sustaining driver 8. The reset discharges mentioned above ensures that a predetermined amount of space charges can be formed in any of the discharge cells.

Further, the number of the reset discharges is varied depending on the type of image to be displayed. Specifically, when a still image is displayed, all of the first through fourth reset discharges are performed. This is done for controlling the amount of residual charges in the discharge cells, which tend to increase due to a large number of times of sustaining discharges over a long time period, to a fixed amount without fail to drive the discharge cells to emit light at intensities corresponding to pixel data.

On the other hand, when a moving image is displayed, only the first and second reset discharges are performed. The display of a moving image, unlike the display of a still image, has a low tendency of increasing the amount of residual charges in the discharge cells, degraded contrast on a displayed image is suppressed by reducing the number of discharges.

The pixel data writing step Wc sets the discharge cells to either of “light emission” and “non-light emission” in accordance with the pixel data bits DB.

By thus increasing or decreasing the number of reset discharges in the simultaneous reset step Rc depending on the type of image to be displayed, it is possible to prevent the burning phenomenon on the PDP.

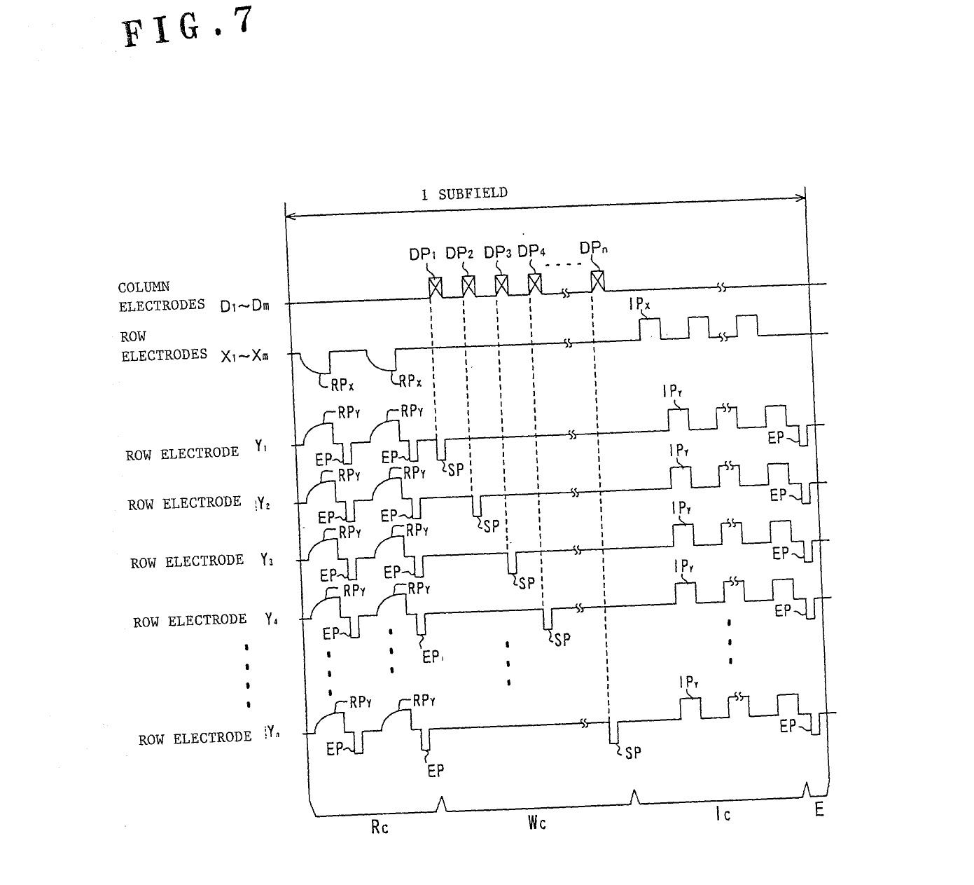

Next, a third embodiment of the present invention will be described with reference to FIGS. 4(a) and 7.

One field is comprised of six subfields, similarly to the first embodiment, and each subfield comprises a simultaneous reset step Rc, a pixel data writing step Wc, a light emission sustaining step Ic, and an erasure step E, as illustrated in FIG. 7. The pixel data writing step Wc, light emission sustaining step Ic, and the erasure step E are similar to the first embodiment, respectively.

In the simultaneous reset step Rc, the first sustaining driver 7 generates reset pulses RP_{X} of positive polarity, which slowly rises, and applies the pulses to the row electrodes X₁-Xₙ. Further, simultaneously with the reset pulses RP_{X}, the second sustaining driver 8 generates reset pulses RP_{Y} of negative polarity, which slowly falls, and applies them to the row electrodes Y₁-Yₙ. In response to the simultaneously applied reset pulses PR_{X} and PR_{Y}, a first reset discharge occurs in all the discharge cells of the PDP 10 to generate a wall charge and a space charge in each discharge cell. Subsequently, the second sustaining driver 8 generates erasure pulses EP of negative polarity which are applied to the row electrodes Y₁-Yₙ. In response to the application of the erasure pulses EP, a discharge occurs in all discharge cells to extinguish wall charges formed in the discharge cells. Further, the application of the reset pulses PR_{X} and PR_{Y} and the erasure pulses EP is again repeated to stably supply space charges to the discharge cells and to set all the discharge cells to the “non-light emitting” state.

The number of reset discharge sets involving the application of the reset pulses and the application of the erasure pulse is increased or decreased depending on the type of image to be displayed, i.e., a still image or a moving image. Specifically, when an image to be displayed is a still image, the discharge set is performed twice. This is because the amount of charges remaining in the discharge cells has been increased due to a large number of times of consecutive sustain discharges when a still image is displayed, so that the amount of residual charges is required to be controlled to a fixed amount by the reset discharges in order to drive the discharge cells to emit light at intensities in accordance with pixel data.

On the other hand, when an image to be displayed is a moving image, the reset discharge set is executed only once.

By thus increasing or decreasing the number of reset discharge sets in the simultaneous reset step Rc depending on the type of image to be displayed, it is possible to prevent the burning phenomenon on the PDP to display an image of good quality.

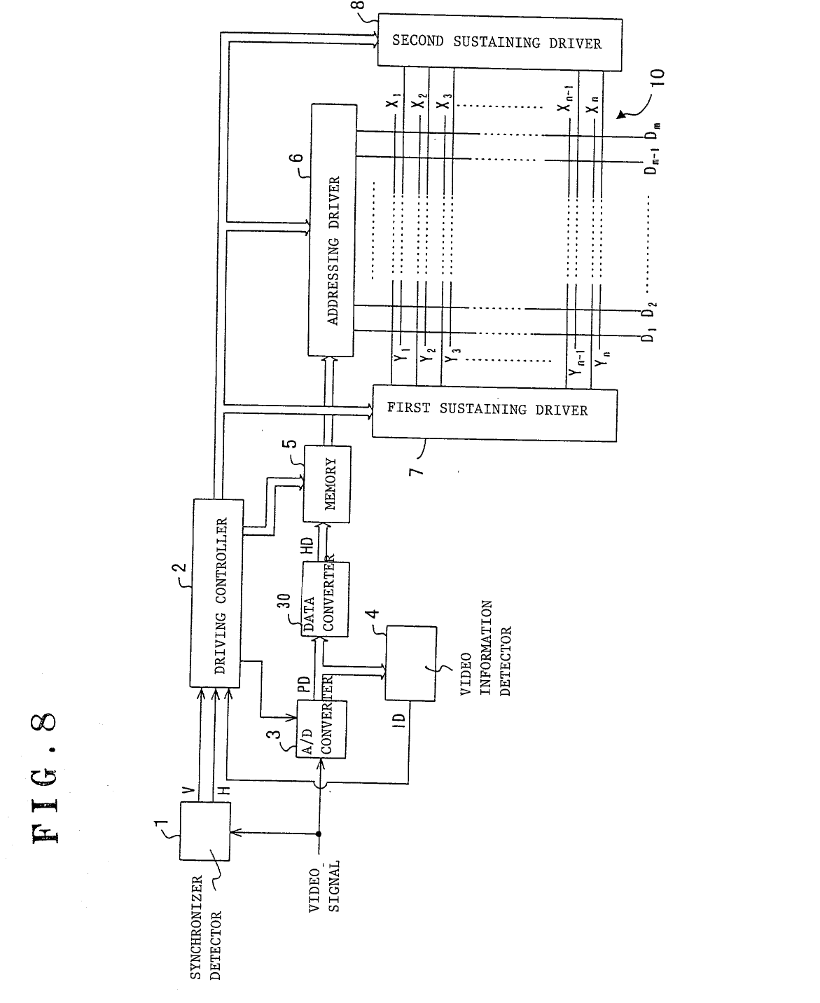

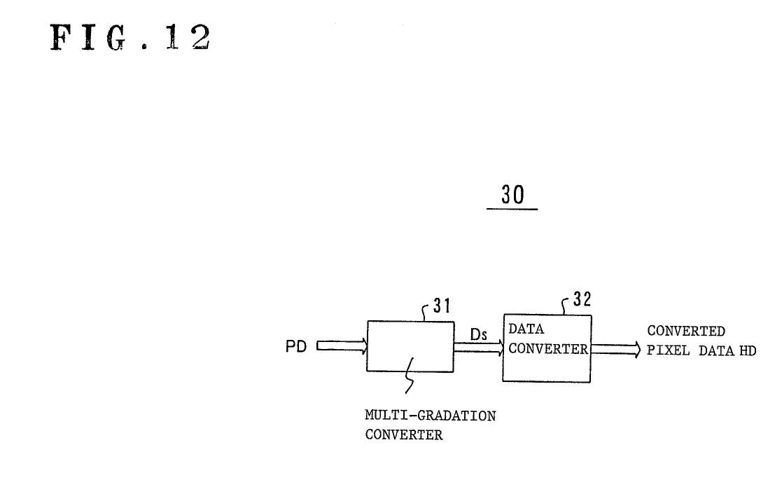

Next, a fourth embodiment of the present invention will be described on the basis of FIGS. 8 through 13.

As illustrated in FIG. 8, a plasma display device of this embodiment comprises a PDP 10 as a plasma display panel, and a driver which is composed of several kinds of functional modules.

The PDP 10 is configured similarly to that of the first embodiment. The driver comprises a synchronizer detector 1, a driving controller 2, an A/D converter 3, an video information analyzer 4, a data converter 30, a memory 5, an addressing driver 6, a first sustaining driver 7, and a second sustaining driver 8. The driver divides one field display period into, for example, six subfields SF1-SF6, as illustrated in FIG. 3, and then drives the PDP 10 based on the aforementioned subfield method. At this time, the driver unit executes a simultaneous reset step Rc, a pixel data writing step Wc, a light emission sustaining step Ic, and an erasure step E respectively in each subfield.

The synchronizer detector 1 detects a vertical synchronization signal from an input video signal to generate a vertical synchronization detecting signal V, and detects a horizontal synchronization signal to generate a horizontal synchronization detecting signal H. The synchronizer detector 1 supplies the vertical and horizontal synchronization detecting signals to the driving controller 2.

The A/D converter 3 samples an analog input video signal in response to a clock signal supplied from the driving controller 2, converts a sampled signal to 8-bit pixel data (input pixel data) D for each pixel, and supplies the converted signal to the data converter 30.

The driving controller 2 generates the clock signal to the A/D converter 3 and a write/read signal to the memory 5 in synchronism with the horizontal and vertical synchronization signals V, H in the input video signal. The driving controller 2 also generates several kinds of timing signals for controlling the addressing driver 6, first sustaining driver 7, and second sustaining driver 8, respectively, in synchronism with the horizontal and vertical synchronization signals.

The data converter 30 converts 8-bit pixel data D to 8-bit converted pixel data (display pixel data) HD, and supplies 8-bit converted pixel data to the memory 5.

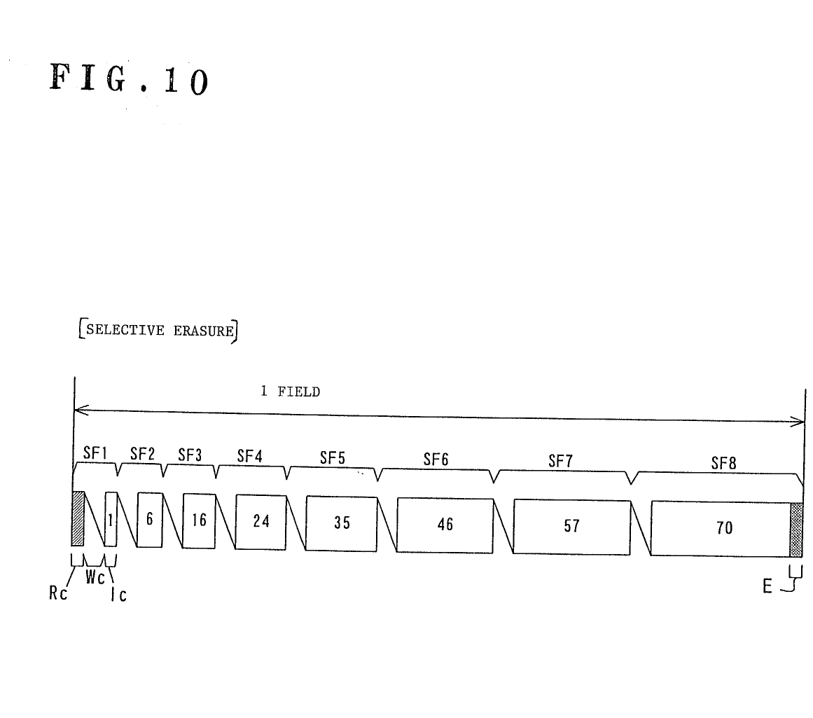

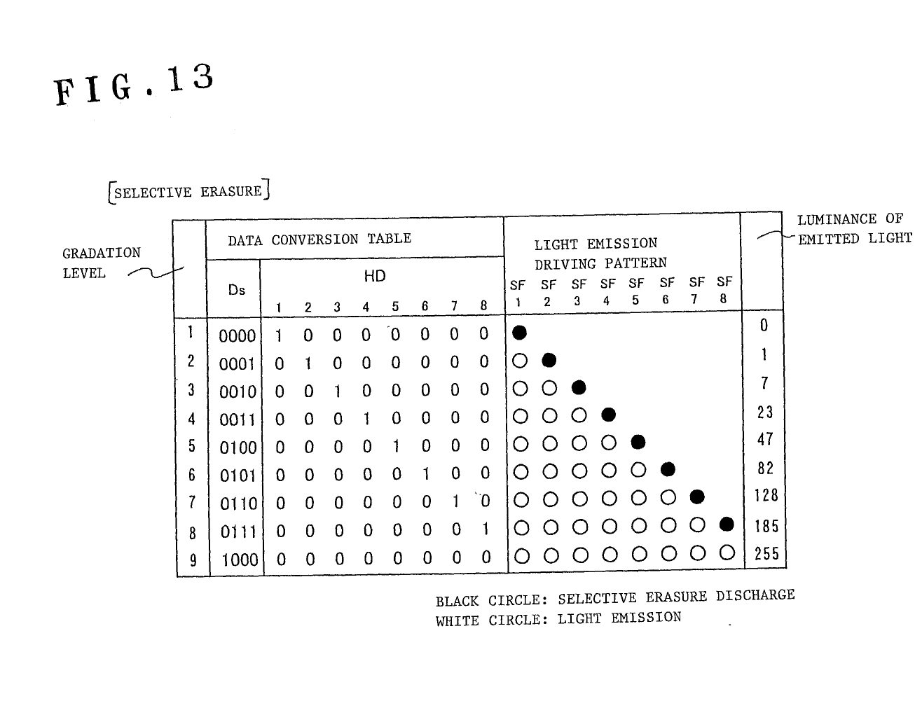

This data converter 30 comprises a multi-gradation processor 31 and a data converter 32. The multi-gradation processor 31 applies 8-bit pixel data PD with multi-gradation processes such as an error diffusion process and a dither process. In this way, the multi-gradation processor 31 generates multi-gradation pixel data D_{S}, the bit number of which is reduced, for example, to four bits as illustrated in FIG. 13, while maintaining the number of gradation levels representation of visual luminance substantially at 256 gradation levels. The data converter 32 in turn converts the multi-level gradation pixel data DS to converted pixel data (display pixel data) HD comprised of first through eighth bits corresponding to each of subfields SF1-SF8 in FIG. 10 in accordance with a conversion table shown in FIG. 13. In FIG. 13, a bit at logical level “1” in the first through eighth bits in the converted pixel data HD indicates that a selective erasure discharge is performed in the pixel data writing step Wc in a subfield SF (indicated by a black circle).

The memory 5 sequentially writes the converted pixel data HD in response to a write signal supplied from the driving controller 2. As the writing is completed for one screen (n rows, m columns) by the writing operation, the memory 5 reads one screen of converted pixel data HD₁₁₋ₙₘ divided for each bit digit, and sequentially supplies the read pixel data to the addressing driver 6 on a row by row basis.

The addressing driver 6 generates m pixel data pulses having a voltage corresponding to a logical level of each of converted pixel data bits for each line read from the memory 5 in response to a timing signal supplied from the driving controller 2, and applies m pixel data pulses to the column electrodes D₁-Dₘ of the PDP 10, respectively.

The PDP 10 comprises the column electrodes D₁-Dₘ as address electrodes, and the row electrodes X₁-Xₙ and row electrodes Y₁-Yₙ, which are arranged to intersect each of these column electrodes. In the PDP 10, row electrodes corresponding to one line are formed by a pair of these row electrode X and row electrode Y. Specifically, the first row electrode pair in the PDP 10 is row electrodes X₁ and Y₁, and an n-th row electrode pair is row electrodes Xₙ and Yₙ. The row electrodes and column electrodes are covered with a dielectric layer, separating from a discharge space. A discharge cell corresponding to one pixel is formed at an intersection of a pair of row electrodes and a column electrode.

Each of the first sustaining driver 7 and the second sustaining driver 8 generates several kinds of driving pulses as described below in response to timing signals supplied from the driving controller 2, and applies the generated pulses to the row electrodes X₁-Xₙ and Y₁-Yₙ of the PDP 10.

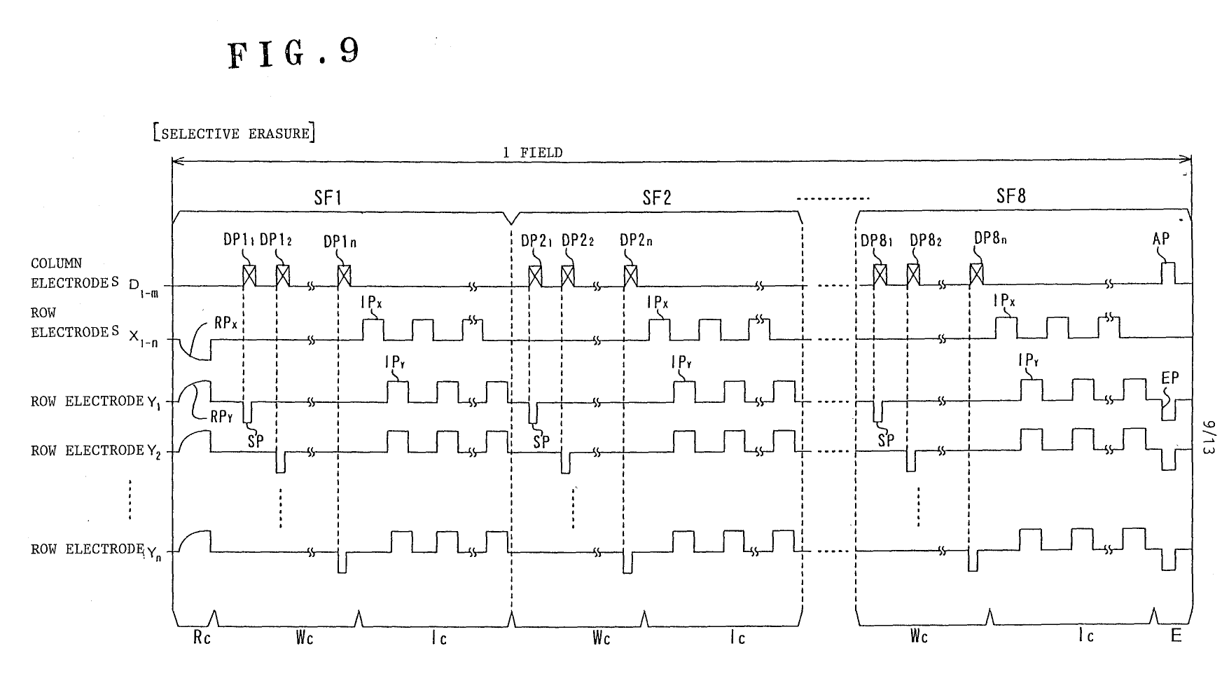

FIG. 9 is a diagram showing application timings of several kinds of driving pulses applied by the addressing driver 6, sustaining driver 7, and second sustaining driver 8 to the column electrode D₁-Dₘ and the row electrodes X₁-Xₙ and Y₁-Yₙ, of the PDP 10.

In an embodiment illustrated in FIG. 9, one field display period is divided into eight subfields SF1-SF8 for driving the PDP 10. In each subfield, the pixel data writing step Wc for writing pixel data into each of discharge cells of the PDP 10 for setting light emitting cells and a non-light emitting cells, and the light emission sustaining step Ic for forcing only the light emitting cells to sustain light emission for a period (number of times) corresponding to weighting of each subfield are performed. Also, only in the first subfield SF1, the simultaneous reset step Rc for initializing all the discharge cells of the PDP 10 is performed, while the erasure step E is performed only in the last subfield SF8.

First, in the simultaneous reset step Rc, the discharge cells are discharged for resetting by the application of reset pulses from the first sustaining driver 7 and the second sustaining driver 8 to uniformly form a predetermined amount of wall charge and space charge in each discharge cell, the details of which will be described later.

Next, in the pixel data writing step Wc, the addressing driver 6 sequentially applies the column electrodes D₁-Dₘ with pixel data pulse groups DP1₁₋ₙ, DP2₁₋ₙ, DP3₁₋ₙ, . . . , DP8₁₋ₙ of each row, as shown in FIG. 9. Specifically, in the subfield SF1, the addressing driver 6 sequentially applies pixel data pulse group DP11-n corresponding to each of the first through n-th rows, generated on the basis of the first bit of each of the converted pixel data HD₁₁₋ₙₘ, to the column electrodes D₁-Dₘ on a row by row basis. Also, in the subfield SF2, the addressing driver 6 sequentially applies the pixel data pulse group DP2, generated on the basis of the second bit of each of the converted pixel data HD₁₁₋ₙₘ, to the column electrodes D₁-Dₘ on a row by row basis. In this event, the addressing driver 6 generates a pixel data pulse at a high voltage and applies the generated pixel data pulse to the column electrodes D only when a bit logic of the converted pixel data is at a logical level “1,” for example. At the same timing as the application timing of each of the pixel data pulse groups DP, the second sustaining driver 8 generates a scanning pulse SP and sequentially applies the generated pulse to the row electrodes Y₁-Yₙ. Here, a discharge occurs only in discharge cells at intersections of “row electrodes” applied with the scanning pulse SP and “column electrodes” applied with the pixel data pulse at the high voltage (selective erasure discharge), so that wall charges so far remaining in the discharge cells are selectively erased. With the discharge, discharge cells initialized to the light emitting cell state in the simultaneous reset step Rc transitions to non-light emitting cells. On the other hand, no discharge is produced in discharge cells which are formed on “column electrodes” that are not applied with the pixel data pulse at the high voltage, so that the discharge cells maintain the state initialized in the simultaneous reset step Rc, i.e., the light emitting cell state.

Specifically, as a result of the performance of the pixel data writing step Wc, each of light emitting cells is set to either of the light emitting state and non-light emitting state in the light emission sustaining step (later described) in accordance with pixel data to perform so-called pixel data writing.

Also, in the light emission sustaining step Ic, the first sustaining driver 7 and the second sustaining driver 8 alternately apply the sustaining pulses IP_{X} and IP_{Y} to the row electrodes X₁-Xₙ and Y₁-Yₙ. In this event, the discharge cells in which the wall charges remain by the pixel data writing step Wc, i.e., the light emitting cells repeat discharge light emission to maintain their light emitting state in a period in which the sustaining pulses IP_{X} and IP_{Y} are being alternately applied. The light emission sustaining period (the number of discharges) is set corresponding to weighting for each subfield.

FIG. 10 is a diagram illustrating a light emission driving format in which a light emission sustaining period (the number of discharges) is described for each subfield.

Specifically, in one field display period, the light emitting duration in the light emission sustaining step Ic is set for each of the subfields SF1-SF8 as follows:

SF1: 1

SF2: 6

SF3: 16

SF4: 24

SF5: 35

SF6: 46

SF7: 57

SF8: 70

Specifically, in each light emission sustaining step Ic, a discharge is produced only in discharge cells which are set to light emitting cells in the pixel data writing step Wc that has been performed immediately before that, to emit light for a light emitting duration shown in FIG. 10 in one field display period.

In the erasure step E, the addressing driver 6 generates erasure pulses AP and applies them to each of the column electrodes D₁-Dₘ. Further, the second sustaining driver 8 generates erasure pulses EP simultaneously with the application timing of the erasure pulses AP, and applies the erasure pulses EP to each of the row electrodes Y₁-Yₙ. With the simultaneous application of the erasure pulses AP and EP, a discharge is produced in all the discharge cells in the PDP 10 to extinguish wall charges remaining in all the discharge cells.

In other words, by performing the erasure step E, all the discharge cells in the PDP 10 become non-light emitting cells.

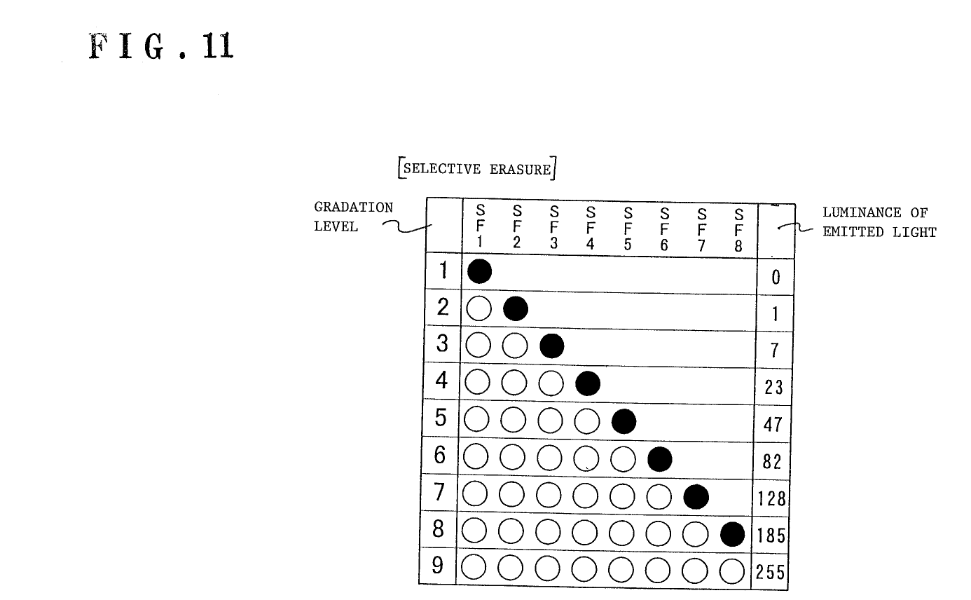

FIG. 11 is a diagram showing all patterns of light emission driving performed on the basis of the light emission driving format illustrated in FIG. 10.

As illustrated in FIG. 11, a selective erasure discharge is performed for each discharge cell only in the pixel data writing step Wc in one of the subfields SF1-SF8 (indicated by a black circle). Specifically, the wall charges formed in all the discharge cells of the PDP 10 by performing the simultaneous reset step Rc remain until the selective erasure discharge is performed. The wall charges then promotes discharge light emission in the light emission sustaining step Ic in each of subfields SF intervening therebetween (indicated by a white circle). Thus, each discharge cell becomes a light emitting cell until the selective erasure discharge is performed in the subfields indicated by black circles in FIG. 10. Thus, light emission is performed at a light emitting duration ratio as indicated in FIG. 10 in the light emission sustaining step Ic in each of the subfields intervening therebetween.

At this time, as shown in FIG. 11, the number of time by which each discharge cell transitions from a light emitting cell to a non-light emitting cell is ensured to be only once in one field period. In other words, a light emission driving pattern which allows a discharge cell, which has been once set to a non-light emitting cell in one field period, to return again to a light emitting cell in the same field period, is prohibited.

Thus, the simultaneous reset operation which involves emission of strong light, though not contributing to image display, is required to be performed only once in one field period as shown in FIGS. 9 and 10, so that a reduction in the contrast can be suppressed.

Also, since the selective erasure discharge performed in one field period is once at most, as shown by the black circles in FIG. 11, the power consumption can be reduced. Further, as shown in FIG. 11, the spurious contour is suppressed.

At this time, according to the light emission driving pattern shown in FIG. 11, light emission driving capable of representing the luminance at nine gradation levels is performed at the following light emission luminance ratio in one field display period:

{0:1:7:23:47:82:128:185:255}

According to the driving, the number of levels of visual display gradation is increased more than nine when integrated in the time direction. Thus, patterns of dither and error diffusion by the multi-level gradation processing, later described, become less prominent, so that S/N ratio is improved.

Next, the simultaneous reset step Rc will be described in detail. The simultaneous reset step Rc performed in this embodiment is identical to the simultaneous reset step shown in FIG. 6. As shown in FIG. 6, in the simultaneous reset step Rc, the first sustaining driver 7 generates reset pulses RPX₁ of positive polarity, which slowly rises for example, and applies the pulses to the row electrodes X₁-Xₙ. Further, simultaneously with the reset pulses RPX₁, the second sustaining driver 8 generates reset pulses RPY₁ of negative polarity, which slowly falls, and applies the pulses to the row electrodes Y₁-Yₙ. In response to the simultaneously applied reset pulses PRX₁ and PRY₁, a first reset discharge occurs in all the discharge cells of the PDP 10 to generate a wall charge and a space charge in each discharge cell. Subsequently, discharges are performed three times, i.e., a second discharge by a second reset pulse PRY₂ from the sustaining driver 8; a third discharge by a third reset pulse RPX₃ from the sustaining driver 7; and a fourth discharge by a fourth reset pulse RPY₄ from the sustaining driver 8. With the reset discharges mentioned above, the amount of space charges in the discharge cells can ensure to be controlled to a predetermined amount.

Further, the number of the reset discharges is increased or decreased depending on the type of an image to be displayed. Specifically, when an image to be displayed is a still image, all of the first through fourth reset discharges are performed. The amount of residual charges in the discharge cells tend to increase due to the same pixel data repeatedly supplied to repeat the same discharge pattern for the sustaining discharge every field. Therefore, the amount of residual charges in the discharge cells is required to ensure to be controlled to a predetermined amount before pixel data is written.

On the other hand, when a moving image is displayed, only the first and second reset discharges are performed.

By thus increasing and decreasing the number of reset discharges in the simultaneous reset step Rc depending on the type of an image to be displayed, it is possible to prevent the burning phenomenon on the PDP.

In the foregoing embodiments, discharge cells are set to either of light emission state and non-light emission state by the selective erasure discharge to write pixel data. It is also with in the scope of the present invention that discharge cells are set to either of light emission state and non-light emission state by selective writing discharge.

It is understood that the foregoing description and accompanying drawings set forth the preferred embodiments of the invention at the present time. Various modifications, additions and alternative designs will, of course, become apparent to those skilled in the art in light of the foregoing teachings without departing from the spirit and scope of the disclosed invention. Thus, it should be appreciated that the invention is not limited to the disclosed embodiments but may be practiced within the full scope of the appended claims.

This application is based on a Japanese patent application No. 2000-168734 which is hereby incorporated by reference.

What is claimed is:

1. A method for driving a plasma display panel comprising a plurality of paired row electrodes, a plurality of column electrodes arranged to cross said plurality of paired row electrodes to form a discharge cell corresponding to a pixel at each intersection with one of said plurality of paired row electrodes, a first driving circuit for generating driving pulses for driving said plurality of paired row electrodes, and a second driving circuit for generating driving pulses for driving said plurality of column electrodes, said method comprising the steps of: sampling input video signals to convert the sampled signals into pixel data for each field display period, dividing each said field display period into a plurality of subfields to perform a gradation display for said input video signals, and performing a reset discharge in said each field display period to initialize all of said discharge cells, wherein the number of reset discharges is increased when an image displayed by said input video signals is a still image.

2. A method for driving a plasma display panel comprising a plurality of paired row electrodes, a plurality of column electrodes arranged to cross said plurality of paired row electrodes to form a discharge cell corresponding to a pixel at each intersection with one of said plurality of paired row electrodes, a first driving circuit for generating driving pulses for driving said plurality of paired row electrodes, and a second driving circuit for generating driving pulses for driving said plurality of column electrodes, said method comprising the steps of sampling input video signals to convert the sampled signals to pixel data every field display period, dividing each said field display period into a plurality of subfields to perform a gradation display of said input video signals, and performing a reset discharge in each one of said subfields to initialize all of said discharge cells, wherein the number of reset discharges is increased when an image displayed by said input video signals is a still image.

3. A method for driving a plasma display panel comprising a plurality of paired row electrodes, a plurality of column electrodes arranged to cross said plurality of paired row electrodes to form a discharge cell corresponding to a pixel at each intersection with one of said paired row electrodes, a first driving circuit for generating driving pulses for driving said plurality of paired row electrodes, and a second driving circuit for generating driving pulses for driving said column electrodes, said method comprising the steps of sampling input video signals to convert the sampled signals into pixel data for each field display period, dividing each said field display period into a plurality of subfields to perform a gradation display of said input video signals, and performing a reset discharge only in a leading subfield in said field to initialize all of said discharge cells, wherein the number of reset discharges is increased when an image displayed by said input video signals is a still image.
